(19) United States
(12) Patent Application Publication
(10) Pub. No.: US 2026/0088486 A1
(43) Pub. Date: Mar. 26, 2026

(54) ANTENNA APPARATUS AND ELECTRONIC DEVICE INCLUDING THE SAME

(71) Applicant: SAMSUNG ELECTRONICS CO., LTD., SUWON-SI (KR)

(72) Inventor: Hyoung Hwan ROH, Suwon-si (KR)

(21) Appl. No.: 19/054,378

(22) Filed: Feb. 14, 2025

(30) Foreign Application Priority Data
Sep. 24, 2024 (KR) 10-2024-0129038

(51) Int. Cl. H01Q 1/22; H01Q 1/24; H01Q 7/00

(52) U.S. Cl. CPC H01Q 1/2283; H01Q 1/243; H01Q 7/00

(57) ABSTRACT

Antenna apparatus and electronic device including the same are provided. The antenna apparatus includes a first and second conductive structures adjacent to one another, and a PCB coupled to the first and second conductive structures, on which a matching circuit and an NFC chip are disposed. The PCB includes first and second ground points reactively coupled to respective feeding ends of the matching circuit. The NFC chip includes a first connection terminal and a second connection terminal, which are configured to provide a differential excitation current, the first and second connection terminals are connected to the feeding ends of the matching circuit, and a current corresponding to an NFC frequency is formed along a loop that includes first and second electrical contacts of the first and second conductive structures, respectively.

### CROSS-REFERENCE TO RELATED APPLICATION

This application is related to and claims priority from Korean Patent Application No. 10-2024-0129038 filed on Sep. 24, 2024 in the Korean Intellectual Property Office and all the benefits accruing therefrom under 35 U.S.C. 119, the contents of which in its entirety are incorporated by reference herein.

### TECHNICAL FIELD

The present disclosure relates generally to an antenna apparatus and an electronic device including the same, and more particularly to an antenna apparatus and electronic device employing Near Field Communication (NFC) technology.

### DISCUSSION OF THE RELATED ART

With the recent development of Near Field Communication (NFC) technology, which is a type of wireless communication technology, an NFC device has been widely applied to a mobile device and the like. In the mobile device, a metal plate disposed at the upper end of the mobile device may be used as an antenna for NFC communication, and in this case, an electric shock or leakage problem may occur. Therefore, a need has arisen for a technology capable of ensuring safety from such an electric shock or leakage problem while using the metal plate disposed at the upper end of the mobile device as an antenna for NFC communication.

### SUMMARY

Embodiments of an antenna apparatus and electronic device disclosed herein may ensure safety from electric shock or leakage during NFC communication.

According to an aspect of the present disclosure, there is provided an antenna apparatus comprising a first conductive structure including a first electrical contact, a second conductive structure adjacent to the first conductive structure, including a second electrical contact, and a printed circuit board (PCB) coupled to the first conductive structure and the second conductive structure, on which a matching circuit and a near field communication (NFC) chip are disposed. The matching circuit includes a first feeding end and a second feeding end, the first feeding end being connected to the first electrical contact, and the second feeding end being connected to the second electrical contact. The PCB includes a first ground point and a second ground point, the first ground point being reactively coupled to the first feeding end, and the second ground point being reactively coupled to the second feeding end, the NFC chip includes a first connection terminal and a second connection terminal, the first connection terminal and the second connection terminal together provide a differential excitation current, the first connection terminal is coupled to the first feeding end through the matching circuit, the second connection terminal is coupled to the second feeding end through the matching circuit, and a current corresponding to an NFC frequency is formed along a loop that includes the first electrical contact and the second electrical contact.

According to an aspect of the present disclosure, there is provided an antenna apparatus comprising a first conductive structure having an oblong profile and including a first electrical contact, a second conductive structure spaced apart from the first conductive structure in an opposite direction of a first direction perpendicular to an edge of a longest dimension of the oblong profile and including a second electrical contact, and a printed circuit board (PCB) coupled to the first conductive structure and the second conductive structure, on which a matching circuit, a near field communication (NFC) chip, a first contact member and a second contact member are disposed, the matching circuit including a first feeding end connected to the first contact member and a second feeding end connected to the second contact member, wherein the NFC chip includes a first connection terminal and a second connection terminal, the first connection terminal and the second connection terminal together provide a differential excitation current, the first connection terminal is connected to the first feeding end through the matching circuit, the second connection terminal is connected to the second feeding end through the matching circuit, when the PCB is coupled to the first conductive structure and the second conductive structure, a current input and output to the NFC chip through the first connection terminal is input and output to the first conductive structure through the first electrical contact, and a current input and output to the NFC chip through the second connection terminal is input and output to the second conductive structure through the second electrical contact, a current corresponding to an NFC frequency is formed along a loop, and the loop is formed across the first conductive structure and the second conductive structure.

According to an aspect of the present disclosure, there is provided an electronic device including a radiator including a first electrical contact and a second electrical contact, an antenna apparatus including a PCB coupled to the radiator, on which a matching circuit and a near field signal exchange chip are disposed, the matching circuit including a first feeding end and a second feeding end, the first feeding end being connected to the first electrical contact, and the second feeding end being connected to the second electrical contact, and a first conductive structure, an edge portion of which forms a portion of the radiator, wherein the first electrical contact is included in the metal frame, and the second electrical contact is included in a second conductive structure spaced apart from the metal frame, the PCB includes a first ground point and a second ground point, the first ground point being reactively coupled to the first feeding end and the second ground point being reactively coupled to the second feeding end, the near field signal exchange chip includes a first connection terminal and a second connection terminal, the first connection terminal and the second connection terminal are configured to provide a differential excitation current, the first connection terminal is connected to the first feeding end through the matching circuit, the second connection terminal is connected to the second feeding end through the matching circuit, and a current corresponding to a near field signal exchange frequency is formed within the first and second conductive structures.

According to an aspect of the present disclosure, a method for near field signal exchange may include: separating a first conductive plate and a second conductive plate by a gap and electrically connecting the first and second conductive plates with a conductive cross member extending across the gap, the first and second conductive plates having first and second contact points, respectively; connecting a first capacitor between the first contact point and a first ground point of a PCB; connecting a second capacitor between the second contact point and a second ground point of the PCB; and generating, by a near field signal exchange circuit having first and second output terminals, a differential excitation current along a loop including the first and second output terminals, the first and second contact points, a first inductor coupled between the first output terminal and the first contact point, and a second inductor coupled between the second output terminal and the second contact point.

The near field signal exchange circuit may be a circuit within an NFC chip. The NFC chip and a matching circuit coupled between the NFC chip and the first and second inductors may be mounted on the PCB.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram illustrating a near field communication (NFC) system according to some embodiments.

FIG. 2 is a diagram illustrating an antenna apparatus of the NFC system of FIG. 1.

FIG. 3 is a diagram illustrating a connection relationship between a matching circuit and an NFC chip in the antenna apparatus of FIG. 2.

FIGS. 4 and 5 are views illustrating an electronic device according to some embodiments.

FIG. 6 is a schematic view illustrating a structure of an electronic device including an antenna apparatus according to some embodiments.

FIGS. 7, 8, 9 and 10 are views illustrating an electronic device including an antenna apparatus according to some embodiments.

FIG. 11 is a view illustrating a matching circuit of an antenna apparatus according to some embodiments.

FIG. 12 is a view illustrating an electronic device including an antenna apparatus according to some embodiments.

FIGS. 13, 14 and 15 are views illustrating an electronic device according to some embodiments.

FIG. 16 is a diagram illustrating an electronic system including an antenna apparatus according to some embodiments.

### DETAILED DESCRIPTION OF EMBODIMENTS

Hereinafter, an antenna apparatus and an electronic device including the same according to some embodiments will be described with reference to the accompanying drawings.

As noted above, in the related art, NFC operation is performed at an upper end of a mobile device by using a structure made of a metal member disposed at the upper end. In some cases, an NFC-only Flexible PCB (FPCB) antenna is attached to a rear surface of the mobile device to implement the NFC operation at the rear of the mobile device. Since NFC operation at the upper end of the mobile device is believed to enhance the user experience, efforts have been made to provide adequate antenna technology at or near the top of the mobile device. However, when an upper metal member is used as an NFC antenna, it is implemented as a single-ended structure, but an NFC chip provides a differential signal to a matching circuit coupled to the antenna. To meet requisite performance, related art designs add a Balanced to Unbalanced (balun) element for converting an unbalanced signal to the matching circuit when the NFC antenna is implemented as a single-ended structure. Also, in the related art, a ground point of a radiator of the upper metal antenna is connected to a ground point of a PCB in which the matching circuit and the NFC chip are disposed (single-ended structure), which constantly or often causes an electric shock/leakage problem.

In embodiments of the present inventive concept such as those described below, the above electric shock/leakage problem may be prevented or alleviated. For instance, embodiments may form effective antennas for both NFC communication and non-NFC communication (e.g., far-field communication) by sharing a first (upper) metal plate disposed on an upper end of a mobile device and a second, larger metal plate (sometimes called a “metal body” or “main body portion”) disposed below the first metal plate. A differential structure for an upper metal antenna may thereby be formed, thereby eliminating the need to add a balun element and also solving the problem of electric shock/leakage.

For instance, in embodiments, a differential NFC signal provided from an NFC chip to a matching circuit is provided as a differential signal (e.g., a first NFC signal and a second NFC signal) through a first feeding end and a second feeding end of the matching circuit. One of the differential signals output from the first feeding end of the matching circuit is provided to the upper metal plate, and the other one thereof is provided to the metal body. Accordingly, the radiator of the antenna, which includes at least a lower portion of the upper metal plate and an upper portion of the metal body, is formed, and a current corresponding to an NFC frequency is formed along a closed loop including the metal frame and the metal body.

In addition, in embodiments, a PCB may include two RF chokes (inductors) that receive the two differential signals output from the matching circuit, respectively. The PCB may further include two capacitors connected to each of the two RF chokes and connected to a respective ground point of the PCB. Thus, when an embodiment of an electronic device housing the antenna operates in a low frequency band (e.g., NFC communication), a current flows to each of the two RF chokes, and the two capacitors are effectively open circuits, thereby preventing the current from flowing to the two capacitors. Conversely, when the electronic device operates in a high frequency band (e.g., non-NFC communication such as LTE, GPS and Wi-Fi), each of the two RF chokes are effectively open circuits, whereby the current does not flow to each of the two RF chokes; instead, the current flows to the two capacitors connected to the ground point of the PCB. Therefore, when the electronic device performs NFC communication, it can be free from the problem of electric shock/leakage because the ground of the PCB and the radiator of the upper metal antenna are electrically separated from each other.

Moreover, since the upper metal NFC antenna of the differential structure is shared not only as an antenna for NFC communication but also as an antenna for non-NFC communication, the two RF chokes disposed on the PCB also serve to prevent the quality of NFC communication from being degraded due to interference of non-NFC communication, by removing a frequency component of the high frequency band that may otherwise impact the NFC communication.

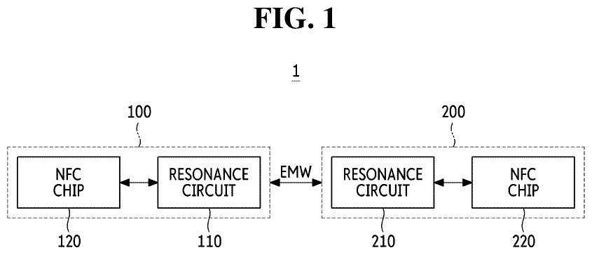

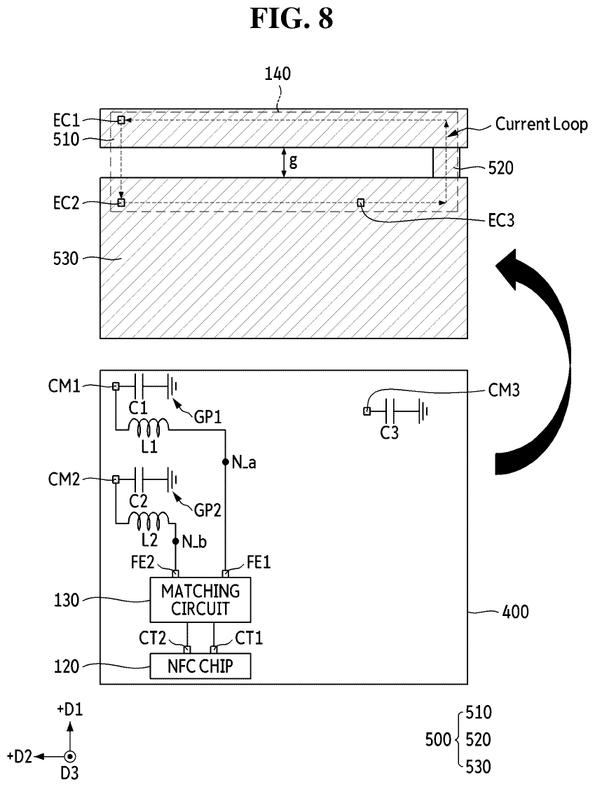

Briefly, in embodiments described below, an antenna apparatus (e.g., 100 or 200, FIG. 1) may include a first conductive structure (e.g., 510, FIG. 8) including a first electrical contact (e.g., EC1); and a second conductive structure (e.g., 530) adjacent to the first conductive structure and including a second electrical contact (e.g., EC2). The antenna apparatus may further include a PCB (e.g., 400), coupled to the first and second conductive structures, on which a matching circuit (e.g., 120) and an NFC chip (e.g., 130) are disposed. The matching circuit may include first and second feeding ends (e.g., FE1 and FE2). The first feeding end may be coupled through a first reactance (e.g., L1) to the first electrical contact, and the second feeding end being coupled through a second reactance (e.g., L2) to the second electrical contact.

The PCB may include first and second ground points (e.g., GP1 and GP2) coupled through third and fourth reactances, respectively (e.g., capacitors C1 and C2) to the first and second feeding ends, respectively. The NFC chip may include first and second connection terminals (e.g., CT1 and CT2), which together provide a differential excitation current. The first and second connection terminals may be coupled to the first and second feeding ends, respectively, through the matching circuit. A current corresponding to an NFC frequency may be formed along a loop that includes the first electrical contact and the second electrical contact.

FIG. 1 is a diagram illustrating a near field signal exchange system according to some embodiments, which will be exemplified hereinafter as a near field communication (NFC) system.

Referring to FIG. 1, an NFC system 1 may include an antenna apparatus 100 and an antenna apparatus 200. In the NFC system 1, the antenna apparatuses 100 and 200 may perform communication with each other based on an NFC method. The antenna apparatus 100 may transmit and receive data to and from the antenna apparatus 200 based on an electromagnetic wave EMW provided from the antenna apparatus 200 (or NFC reader) in a card mode operating as a card. Additionally or alternatively, the antenna apparatus 100 may transmit and receive data to and from the antenna apparatus 200 based on the electromagnetic wave EMW generated by the antenna apparatus 100 in a reader mode operating as a reader.

The antenna apparatus 100 may include a resonance circuit 110 and a near field signal exchange chip, hereafter exemplified as an NFC chip 120. The antenna apparatus 200 may include a resonance circuit 210 and a near field signal exchange chip, hereafter exemplified as an NFC chip 220. In the receiving operation, the resonance circuit 110 may receive input data from the antenna apparatus 200 through the electromagnetic wave EMW, and the NFC chip 120 may receive the input data from the resonance circuit 110. In the transmitting operation, the NFC chip 120 may provide output data to the resonance circuit 110, and the resonance circuit 110 may transmit the output data to the antenna apparatus 200 through an electromagnetic wave EMW.

In the card mode in which the antenna apparatus 100 operates as a card, the resonance circuit 110 provides the NFC chip 120 with a signal induced in response to the electromagnetic wave EMW received from the antenna apparatus 200, and the NFC chip 120 may perform a reception operation by demodulating the signal to generate input data.

In the card mode in which the antenna apparatus 100 operates as a card, the NFC chip 120 provides a modulated signal generated by modulating the output data to the resonance circuit 110, and the resonance circuit 110 may perform a transmission operation by reflecting the electromagnetic wave EMW received from the antenna apparatus 200 based on the modulated signal.

In the reader mode in which the antenna apparatus 100 operates as a reader, the NFC chip 120 synthesizes the modulated signal generated by modulating the output data with a carrier signal and provides the synthesized signal to the resonance circuit 110 as a transmission signal, and the resonance circuit 110 may perform a transmission operation by providing the transmission signal to the antenna apparatus 200 in the form of the electromagnetic wave EMW.

In the reader mode in which the antenna apparatus 100 operates as a reader, the resonance circuit 110 provides the NFC chip 120 with a signal induced in response to the electromagnetic wave EMW reflected from the antenna apparatus 200, and the NFC chip 120 may perform a reception operation by demodulating the signal to generate the input data.

NFC technology is a non-contact near field communication standard that enables wireless communication between electronic devices with low power over a short distance of 10 cm or less by using a frequency of 13.56 MHz. The NFC technology has a transmission speed per second of 424 Kbps, has excellent security due to the nature of proximity and encryption technique, and may recognize terminals at 1/10 second or less without the need for a complicated pairing process. In particular, the NFC technology is based on RFID technology, but has bidirectional characteristics compared to smart cards, has a relatively large storage memory space, and has a wider range of applicable services.

NFC is a type of near field signal exchange, and a type of an RFID method as a wireless communication method for directly exchanging data between terminals, for example, the antenna apparatus 100 and the antenna apparatus 200, without using a communication network. Wireless communication methods using RFID may be classified depending on the frequencies used. For example, there are RFID of a band of 13.56 MHz, which is mainly used for smart cards such as transportation cards and access cards, and RFID of a band of 900 MHz, which is mainly used for logistics. NFC corresponds to RFID that uses a frequency in a band of 13.56 MHz like the smart cards. However, unlike the smart cards that enable communication only in one direction, NFC differs by enabling bidirectional communication.

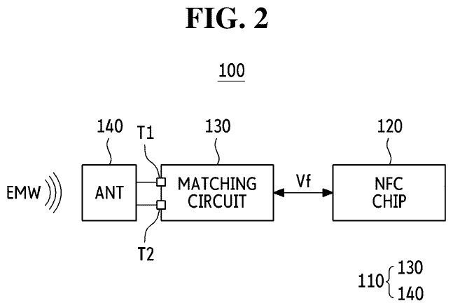

FIG. 2 is a diagram illustrating an example of an antenna apparatus of the NFC system of FIG. 1.

Referring to FIG. 2, the antenna apparatus 100 may include a resonance circuit 110 and an NFC chip 120. The resonance circuit 110 may include an antenna 140 and a matching circuit 130. The antenna 140 may be implemented using a metallic material. A shape of the antenna 140 according to the present disclosure will be described later with reference to FIG. 8, etc. The matching circuit 130 may be connected to a first terminal T1 and a second terminal T2 of the antenna 140. The matching circuit may “respond” to the electromagnetic wave EMW by reducing reflected power, and may generate a field voltage Vf corresponding to the electromagnetic wave.

The NFC chip 120 may detect whether an NFC card or an NFC reader is present therearound based on a magnitude of the field voltage Vf. When the NFC chip 120 detects the NFC card, the NFC chip 120 may set a resonance frequency of the matching circuit 130 to a first optimal frequency based on the magnitude of the field voltage Vf and operate in the reader mode. When the NFC chip 120 detects the NFC reader, the NFC chip 120 may set the resonance frequency of the matching circuit 130 to a second optimal frequency based on at least one of the magnitude of the field voltage Vf or a magnitude of an internal current generated in response to the electromagnetic wave and operate in the card mode.

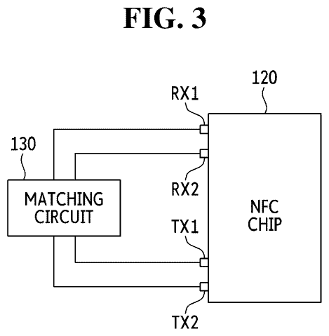

FIG. 3 is a diagram illustrating a connection relationship between a matching circuit and an NFC chip in the antenna apparatus of FIG. 2.

Referring to FIG. 3, the matching circuit 130 may be connected to the NFC chip 120 through a first reception terminal RX1, a second reception terminal RX2, a first transmission terminal TX1 and a second transmission terminal TX2. The NFC chip 120 may perform a transmission operation through the first transmission terminal TX1 and the second transmission terminal TX2 in an active mode, and may perform a reception operation through the first reception terminal RX1 and the second reception terminal RX2.

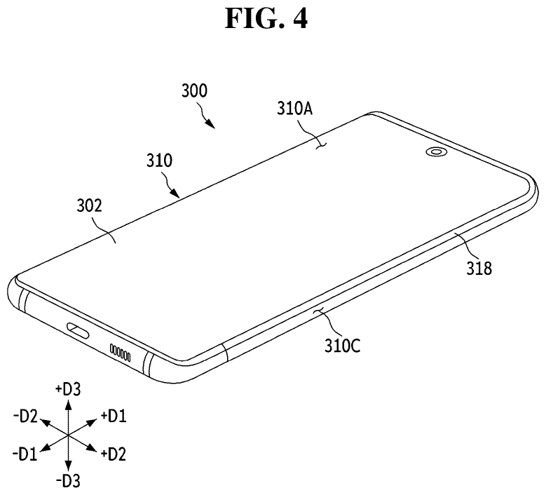

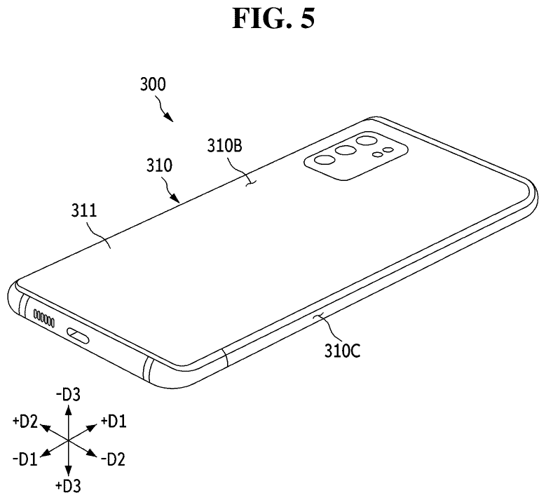

FIGS. 4 and 5 are views illustrating an electronic device according to some embodiments. FIG. 4 illustrates a front surface (e.g., a display side) and a side surface of the electronic device 300, whereas FIG. 5 illustrates a rear surface and a side surface of the electronic device 300.

In the following description, a first direction +D1 and a first direction −D1 may be opposite to each other, a second direction +D2 and a second direction −D2 may be opposite to each other, and a third direction +D3 and a third direction −D3 may be opposite to each other. In addition, the first direction +D1, the first direction +D2 and the third direction +D3 may intersect with one another. For example, the first direction +D1, the second direction +D2 and the third direction +D3 may be orthogonal to one another.

The electronic device 300 may include the antenna apparatus 100 described with reference to FIGS. 1 to 3. For example, the electronic device 300 may perform communication with another NFC device based on an NFC method. The electronic device 300 may operate as an NFC card or as an NFC reader, but the embodiment is not limited thereto. For example, the electronic device 300 may perform communication with another electronic device based on a near field signal exchange method other than the NFC method (as mentioned above), and/or may perform far-field antenna to antenna communication (hereafter referred to as a “non-NFC”method or communication) based on other protocols. For example, the electronic device 300 may perform far-field communication with another electronic device based on a non-NFC method such as a long-term evolution (LTE), a global positioning system (GPS) and a wireless fidelity (Wifi).

Although FIGS. 4 and 5 illustrate that the electronic device 300 is implemented as a portable communication device (e.g., a smartphone), the type of the electronic device 300 is not limited thereto. The electronic device 300 includes the antenna apparatus 100 described with reference to FIGS. 1 to 3, and may be an electronic device that performs communication with other electronic devices based on NFC communication and non-NFC communication. Some examples of the electronic device 300 may include a computer device, a portable multimedia device, a portable medical device, a camera, a wearable device, and/or a home appliance, but other examples are also possible.

Referring to FIGS. 4 and 5, the electronic device 300 may include a housing 310 that includes a first surface (e.g., front surface) 310A directed toward the third direction +D3, a second surface (e.g., rear surface) 310B directed toward the third direction (−D3) opposite to the third direction +D3, and a side surface (or sidewall) 310C surrounding a space between the first surface 310A and the second surface 310B.

The first surface 310A may be formed by a front plate 302 (e.g., a glass plate including various coating layers or a polymer plate) in which at least a portion is substantially transparent. According to an embodiment, the front plate 302 may include a major surface that is flat and a curved portion that is bent from the first surface 310A toward the rear plate 311 and seamlessly extended.

The second surface 310B may be formed by the rear plate 311 that is substantially opaque. The rear plate 311 may be formed by, for example, coated or colored glass, ceramic, polymer, metal (e.g., aluminum, stainless steel (STS) or magnesium), or a combination of at least two of the above materials.

The rear plate 311 may include a curved portion that is bent from the second surface 310B toward the front plate 302 and seamlessly extended. The side 310C is coupled to the front plate 302 and the rear plate 311, and may be formed by a side bezel structure (or “side member or sidewall”) 318 containing metal and/or a polymer. In some embodiments, the rear plate 311 and the side bezel structure 318 may be integrally formed, and may include the same material (e.g., a metallic material such as aluminum).

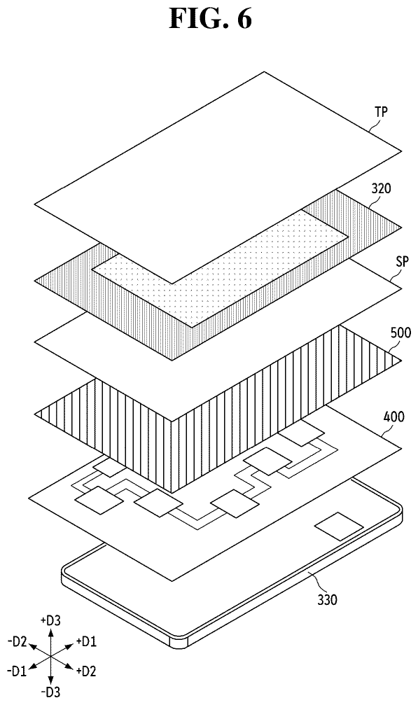

FIG. 6 is an exploded perspective view separately illustrating components included in the electronic device 300 of FIGS. 4 and 5, according to an embodiment. However, FIG. 6 illustrates only some of the components included in the electronic device 300 for convenience of description, and the electronic device 300 may further include other components in addition to the components shown in FIG. 6.

Referring to FIG. 6, the electronic device 300 may include a transparent plate TP, a display 320, a support member SP, a metal member 500, a printed circuit board (PCB) 400, and a rear plate 330.

The transparent plate TP may correspond to the front plate 302 of FIG. 3. The transparent plate TP may form a first surface 310A (shown in FIG. 4) of the electronic device 300. The transparent plate TP may be formed of a transparent polymer material such as polycarbonate (PC), polymethyl methacrylate (PMMA), polyimide (PE), polyethylene terephthalate (PET) and polypropylene terephthalate (PPT), or a glass material. However, the transparent polymer or the glass material is merely an example of a material on which the transparent plate TP may be formed, and the material of the transparent plate TP is not limited thereto.

The support member SP may support electronic components disposed inside the electronic device 300. The support member SP may support the transparent plate TP, and may be formed to surround the display 320 to be described later. Also, the support member SP may support the PCB 400 to be described later.

The display 320 may be formed of a plurality of layers, and may be disposed between the transparent plate TP and the support member SP. The display 320 may include a base substrate, a thin film transistor (TFT) layer, an electrode layer, an organic material layer, or a pixel layer. At least a portion of the display 320 may be seen to the outside of the electronic device 300 through the transparent plate TP. The display 320 may emit light from a pixel to transmit information to a user, and the emitted light may be transferred to the outside through the transparent plate TP.

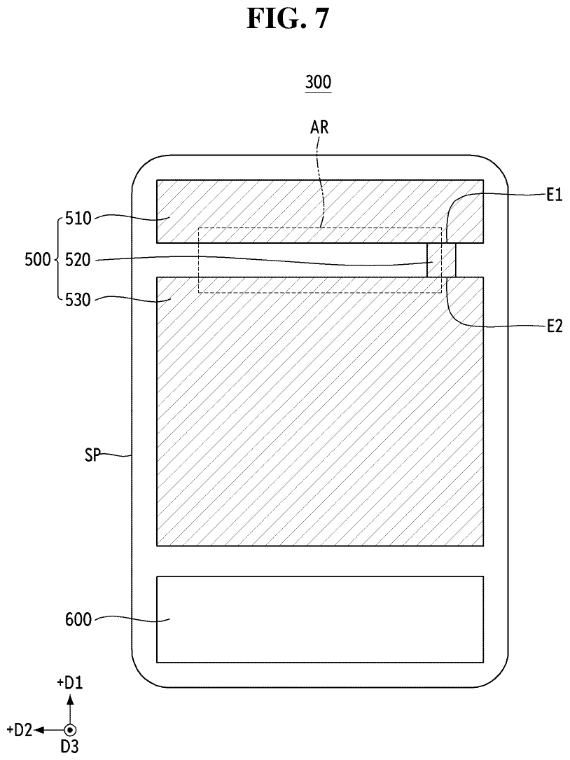

The metal member 500 (alternatively, composed of a conductive structure other than metal) may be disposed between the support member SP and the PCB 400. The metal member 500 may include a first conductive structure 510 and a second conductive structure 530, which will be described later with reference to FIG. 7, etc. The metal member 500 may include a conductive material such as metal. At least a portion of the metal member 500 may function as an NFC antenna for NFC communication of the electronic device 300.

Also, at least a portion of the metal member 500 may function as an antenna for non-NFC communication of the electronic device 300. The NFC communication and non-NFC communication may be performed concurrently. For example, when at least a portion of the metal member 500 is implemented as an antenna, the antenna may be shared by the electronic device 300 as an antenna for performing NFC communication and non-NFC communication.

The PCB 400 may be disposed between the metal member 500 and a rear plate 330. Various electronic devices for operating the electronic device 300 may be disposed on the PCB 400. For example, the PCB 400 may include a matching circuit 130 (shown in FIG. 2) and an NFC chip 120 (shown in FIG. 2). The PCB 400 may be electrically coupled to the metal member 500. When the PCB 400 is coupled to the metal member 500, a signal output from the NFC chip 120 may be input to at least a partial area of the metal member 500, and the signal output from at least a partial area of the metal member 500 may be input to the NFC chip 120 of the PCB 400. In this manner, as the PCB 400 is coupled to the metal member 500, at least a partial area of the metal member 500 may be used as an antenna for NFC communication of the electronic device 300.

Also, the PCB 400 may include a ground point for far-field communication (interchangeably herein, “non-NFC communication”). Accordingly, when the PCB 400 is coupled to the metal member 500, a signal for non-NFC communication, which is output from the PCB 400, may be input to at least a partial area of the metal member 500, and a signal for non-NFC communication, which is output from at least a partial area of the metal member 500, may be input to the PCB 400. Accordingly, at least a partial area of the metal member 500 may be also used as an antenna for non-NFC communication of the electronic device 300.

The rear plate 330 may cover and protect the PCB 400 and the components included in the electronic device 300.

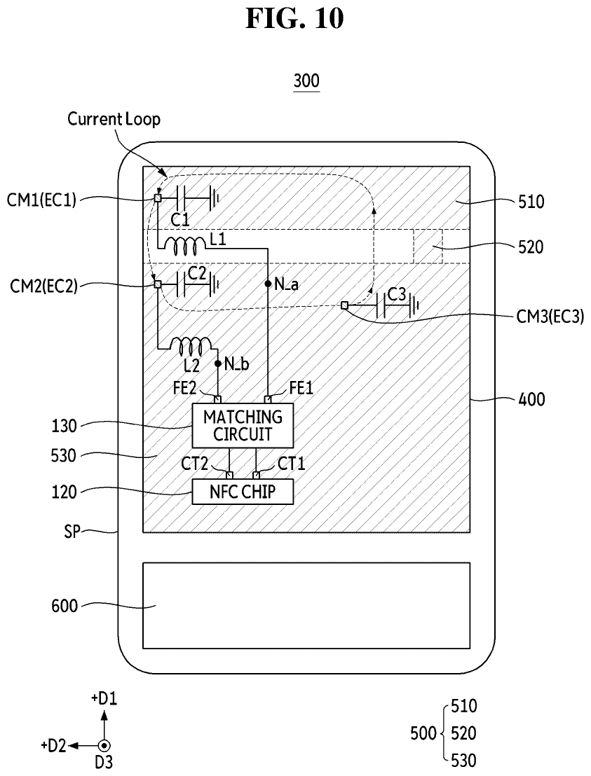

FIGS. 7 to 10 are views illustrating an electronic device including an antenna apparatus according to some embodiments.

In the following description, referring to FIGS. 7-15, the first direction +D1 may mean an upper direction of the electronic device 300, and a first direction −D1 opposite to the first direction +D1 may mean a lower direction of the electronic device 300.

FIG. 7 is a plan view illustrating a rear side of a conductive member 500 coupled to a support member SP. The conductive member 500 may be composed of metal, which will be used as an example in the discussion hereafter (conductive member 500 may be interchangeably called a “metal member 500”). The conductive member 500 may include a first conductive structure 510, a (sometimes referred to a “metal plate” or “metal frame”), a second conductive structure 530 (sometimes referred to as a “main body portion” or a “main body”), and a conductive cross member 520. The first conductive structure 510 may have a smaller profile (in the D1-D2 plane) and a smaller surface area than that of the main body 530. The first conductive structure 510 may be a metal frame. Each of the first conductive structure 510 and the main body 530 may be in the form of a metal plate. The main surfaces of the first and second conductive structures 510 and 530 may each have a rectangular or square profile. (The main surfaces are those in the D1-D2 plane, i.e., the front surfaces of each facing the front surface of the electronic device 300, and the rear surfaces of each facing the rear surface of the electronic device 300, each orthogonal to the thickness direction D3.) The main surfaces of the first conductive structure 510 (i.e., the front surface and the rear surface) may have an oblong profile (e.g., rectangular) with a width (shorter dimension of the oblong profile) smaller than a width of the main body 530, and a length (larger dimension of the oblong profile) equaling the length of the main body 530, as illustrated in FIGS. 7-10.

The first conductive structure 510 may be disposed at an upper end of the electronic device 300, and have a shape extended in a second direction D2 (the lower edge, which is the larger dimension of the oblong profile, extends in the second direction D2). The first conductive structure 510 may be a radiator for receiving an external signal of the electronic device 300 to transfer the external signal to a signal processing device of the electronic device 300. Alternatively or additionally, the first conductive structure 510 may be a radiator for transferring the signal processed within the electronic device 300 to the exterior. For example, the first conductive structure 510 may include a lower end, which may form part of the radiator.

The second conductive structure 530 may be adjacent to the first conductive structure 510. For example, as shown in FIG. 7, the second conductive structure 530 may be disposed below the first conductive structure 510. For example, the first conductive structure 510 may be disposed to be spaced apart from the second conductive structure 530 in the first direction +D1, by a gap “g” which may be substantially smaller than the longest dimension of the oblong profile of the first conductive structure 510 (e.g., about 1/10 as long).

As will be described later, the second conductive structure 530 may include an upper edge region that may form the radiator together with a lower edge region of the first conductive structure 510. For example, the second conductive structure 530 may be a radiator for receiving an external signal of the electronic device 300 and transferring the external signal to the signal processing device of the electronic device 300, and/or may be a radiator for transferring the signal processed inside the electronic device 300 to the exterior.

The conductive cross member 520 may be disposed between the first conductive structure 510 and the second conductive structure 530, proximate a side edge of each of the first and second conductive structures 510 and 530, as illustrated in FIGS. 7-10. The conductive cross member 520 may be extended in the first direction D1 (and have a dimension in the first direction D1 equal to “g”). The conductive cross member 520 may include a first end E1 and a second end E2, which are opposite to each other in the first direction D1. The first end E1 of the conductive member 520 may be connected to the first conductive structure 510, and the second end E2 of the conductive member 520 may be connected to the second conductive structure 530. In some embodiments, the first conductive structure 510, the conductive cross member 520 and the second conductive structure 530 are a continuous, unitary conductive structure. In other embodiments, the conductive cross member 520 is an individual member that is soldered or otherwise electrically and mechanically connected to each of the first and second conductive structures 510 and 530.

A region AR including a lower end of the first conductive structure 510, an upper end of the second conductive structure 530 and the conductive member 520 may be an effective antenna region (a region in which a majority of the antenna current flows) for NFC communication and an antenna for non-NFC communication when the PCB 400 is coupled to the first conductive structure 510 and the second conductive structure 530. In this manner, when the region AR including the lower end of the first conductive structure 510, the upper end of the second conductive structure 530 and the conductive member 520 is used as an antenna for NFC communication of the electronic device 300, the region AR may correspond to the antenna 140 described with reference to FIG. 2.

A battery mounting groove 600 may be provided at a lower end of the second conductive structure 530. The battery mounting groove 600 may accommodate a battery pack. When the battery pack is accommodated in the battery mounting groove 600, the battery mounting groove 600 and the accommodated battery pack may be closed using the rear plate 330 (shown in FIG. 6).

Next, an operation when the PCB 400 is coupled to the first conductive structure 510 and the second conductive structure 530 will be described with reference to FIGS. 8 to 10.

The first conductive structure 510 may include a first electrical contact EC1, and the second conductive structure 530 may include a second electrical contact EC2. The first electrical contact EC1 and the second electrical contact EC2 may be respectively connected to a first contact member CM1 and a second contact member CM2 of the PCB 400, which will be described later, when the PCB 400 is coupled to the first conductive structure 510 and the second conductive structure 530. It is noted here that in some embodiments, the first and second electrical contacts EC1 and EC2 may just be contacts (e.g., pads) protruding from the surfaces of the first and second conductive structures 510 and 530, whereas in other embodiments, they may be just contact surface points of the first and second conductive structures 510 and 530.

As will be described later, the PCB 400 may be electrically coupled to the first conductive structure 510 and the second conductive structure 530. The electrical coupling may be implemented at spaced apart connection points sufficient for the region AR including the lower end of the first conductive structure 510, the upper end of the second conductive structure 530 and the conductive member 520 to function as an antenna for the electronic device 300 to perform NFC communication. In this case, the first electrical contact EC1 and the second electrical contact EC2 may correspond to the first terminal T1 and the second terminal T2 of the antenna 140 responding to the electromagnetic wave EMW described with reference to FIG. 2, respectively. As a result, the current corresponding to the NFC frequency may flow along a current loop shown in FIG. 8.

The PCB 400 may include a near field signal exchange chip 120 (hereafter exemplified as an NFC chip 120), a matching circuit 130, a first inductor L1, a second inductor L2, a first capacitor C1, and a second capacitor C2. The NFC chip 120 may be configured to generate a differential excitation current. The differential excitation current may include two current signals having the same amplitude and opposite phases to each other. For example, the differential excitation current may include two current signals having a phase difference of 180°.

The NFC chip 120 may include a first pair of connections terminals CT1, hereafter just “connection terminal CT1”, and a second pair of connection terminals CT2, hereafter just “connection terminal CT2”. The first connection terminal CT1 may include a first transmission terminal TX1 and a first reception terminal RX1 of FIG. 3, and the second connection terminal CT2 may include a second transmission terminal TX2 and a second reception terminal RX2 of FIG. 3. The first connection terminal CT1 and the second connection terminal CT2 may be configured to provide the differential excitation current generated by the NFC chip 120. For example, when the NFC chip 120 generates a first NFC signal and a second NFC signal, which have the same amplitude and opposite phases to each other, the first connection terminal CT1 and the second connection terminal CT2 may provide the first NFC signal and the second NFC signal to the matching circuit 130, respectively.

The matching circuit 130 may perform impedance matching between the NFC chip 120 and the antenna 140. The matching circuit 130 may include a first feeding end FE1 and a second feeding end FE2. The matching circuit 130 may perform a matching operation for matching impedance of the NFC chip 120 with impedance of the antenna 140 with respect to the first NFC signal and the second NFC signal, which are received from the first connection terminal CT1 and the second connection terminal CT2. The matched signal may be provided to a node N_a and a node N_b through the first feeding end FE1 and the second feeding end FE2, respectively.

The signal provided to the node N_a may be provided to the first contact member CM1 through the first inductor L1 disposed between the first feeding end FE1 and the first contact member CM1. The signal provided to the node N_b may be provided to the second contact member CM2 through the second inductor L2 disposed between the second feeding end FE2 and the second contact member CM2.

The first contact member CM1 and the second contact member CM2 may be conductive members for electrically connecting the PCB 400 to the first conductive structure 510 and the second conductive structure 530 when the PCB 400 is mechanically/electrically coupled to the first conductive structure 510 and the second conductive structure 530. For example, the first contact member CM1 and the second contact member CM2 may be C-clips used for antenna contact.

A first end of the first capacitor C1 may be connected to the first contact member CM1, and a second end thereof may be grounded by being connected to a first ground point GP1 of the PCB 400 (see FIG. 8). A first end of the second capacitor C2 may be connected to the second contact member CM2, and a second end thereof may be grounded by being connected to a second ground point GP2 (see FIG. 8) of the PCB 400 which may be spaced apart from the first ground point GP1. In other examples, the first ground point GP1 and the second ground point GP2 are approximately at the same location.

The second conductive structure 530 may further include a third electrical contact EC3, and the PCB 400 may further include a third contact member CM3 and a third capacitor C3. A first end of the third capacitor C3 may be connected to the third contact member CM3, and a second end thereof may be grounded by being connected to a ground point of the PCB 400. When the PCB 400 is coupled to the second conductive structure 530, the third electrical contact EC3 and the third contact member CM3 may be electrically connected to each other. The third contact member CM3 may receive a signal for non-NFC communication from an electronic element (not shown) for non-NFC communication of the electronic device 300 packaged on the PCB. Accordingly, when the PCB 400 is coupled to the second conductive structure 530, the signal for non-NFC communication, which is provided from the PCB, may be provided to the third electrical contact EC3, and the corresponding signal may be transmitted to the exterior of the electronic device 300 through the antenna 140. In this manner, the antenna 140 may be used as an antenna for NFC communication of the electronic device 300 and at the same time may be also used as an antenna for non-NFC communication of the electronic device 300.

Although FIG. 8 shows that the third electrical contact EC3 is disposed on the second conductive structure 530, in other embodiments, the third electrical contact EC3 is disposed on the first conductive structure 510.

In this manner, since the antenna 140 is used for NFC communication of the electronic device 300 and also for non-NFC communication of the electronic device 300, when the antenna 140 is used for NFC communication, it may be desirable to reduce an influence due to characteristics of non-NFC communication. In the present embodiment, this may be accomplished with the first inductor L1 connected between the first feeding end FE1 and the first contact member CM1, and the second inductor L2 connected between the second feeding end FE2 and the second contact member CM2.

NFC communication uses, for example, a relatively low frequency of 13.56 MHz, and non-NFC communication (for example, LTE, Wi-Fi, etc.) uses a relatively higher frequency than NFC communication. At a low frequency band at which the electronic device 300 performs NFC communication, no current may flow to the first capacitor C1 and the second capacitor C2, and the current may flow to the first inductor L1 and the second inductor L2. For example, when the PCB 400 is coupled to the first conductive structure 510 and the second conductive structure 530, the first contact member CM1 may be electrically connected to the first electrical contact EC1, and the second contact member CM2 may be electrically connected to the second electrical contact EC2. Then, a differential NFC signal (i.e., a differential excitation current) generated by the NFC chip 120 may be provided to each of the node N_a and the node N_b through the matching circuit 130. The current provided to the node N_a may flow to the first inductor L1, be provided to the first contact member CM1, and then may be provided to the first conductive structure 510 electrically connected to the first contact member CM1 through the first electrical contract EC1. Furthermore, the current provided to the node N_b may flow to the second inductor L2, be provided to the second contact member CM2, and then may be provided to the second conductive structure 530 electrically connected to the second contact member CM2 through the second electrical contact EC2. In this case, since the electronic device 300 operates at the low frequency band, the current of the node N_a may not flow to the first capacitor C1, and the current of the node N_b may not flow to the second capacitor C2.

Conversely, at a high frequency band at which the electronic device 300 performs far-field antenna to antenna communication, e.g., non-NFC communication, the current may flow to the first capacitor C1 and the second capacitor C2, and no current may flow to the first inductor L1 and the second inductor L2.

In this manner, the first inductor L1 and the second inductor L2, which serve as RF chokes for removing a high frequency component, may be added between the first feeding end FE1 and the first contact member CM1 and between the second feeding end FE2 and the second contact member CM2. Thus, when the antenna 140 is used for NFC communication, the influence due to the characteristics of the non-NFC communication may be reduced.

Also, as described above, no current may flow to the first capacitor C1 and the second capacitor C2 at the low frequency band at which the electronic device 300 performs NFC communication. Therefore, no current flows to the first ground point GP1 of the PCB 400 connected to the first capacitor C1 and the second ground point GP2 of the PCB 400 connected to the second capacitor C2, and the radiator of the antenna 140 may be electrically separated from any ground point of the PCB. Therefore, an electric shock or leakage problem (as in a conventional antenna apparatus) that may occur when the radiator of the antenna 140 is connected to a ground point of the PCB, may be prevented or alleviated.

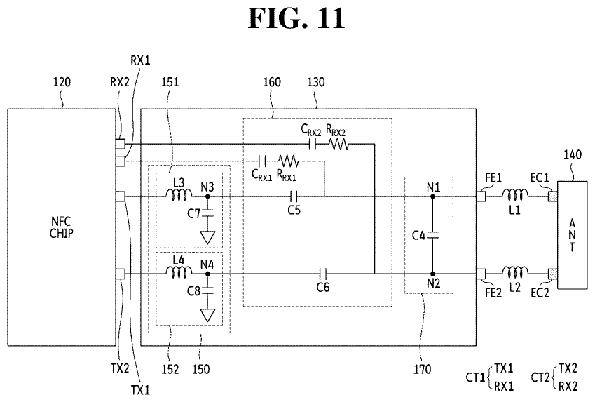

FIG. 11 schematically illustrates a matching circuit of an antenna apparatus according to some embodiments.

Referring to FIG. 11, the matching circuit 130 may include a resonance circuit part 170, a matching sub-circuit 160, and a filter circuit 150. The resonance circuit part 170 may include a fourth capacitor C4 connected in parallel with the antenna 140 between the first electrical contact EC1 corresponding to the first terminal T1 (shown in FIG. 2) and the second electrical contact EC2 corresponding to the second terminal T2 (shown in FIG. 2) of the antenna 140. A first end of the fourth capacitor C4 may be connected to a node N1, and a second end of the fourth capacitor C4 may be connected to a node N2. The fourth capacitor C4 may be connected to the first inductor L1 through the first feeding end FE1 at the node N1, and may be connected to the second inductor L2 through the second feeding end FE2 at the node N2.

The matching sub-circuit 160 may include a fifth capacitor C5, a sixth capacitor C6, a first reception capacitor C_{RX1}, a second reception capacitor C_{RX2}, a first reception resistor R_{RX1}, and a second reception resistor R_{RX2}. The fifth capacitor C5 may be connected between the node N1 and a node N3, and the sixth capacitor C6 may be connected between the node N2 and a node N4. The fifth capacitor C5 and the sixth capacitor C6 may be connected in series with respect to the antenna 140.

A first end of the first reception capacitor C_{RX1} may be connected to the first reception terminal RX1, a second end of the first reception capacitor C_{RX1} may be connected to the first end of the first resistor R_{RX1}, and a second end of the first reception resistor R_{RX1} may be connected to the node N1. A first end of the second reception capacitor C_{RX2} may be connected to the second reception terminal RX2, a second end of the second reception capacitor C_{RX2} may be connected to the first end of the second reception resistor R_{RX2}, and a second end of the second reception resistor R_{RX2} may be connected to the node N2.

The first reception capacitor C_{RX1} and the first reception resistor R_{RX1} are connected between the first reception terminal RX1 and the first end (i.e., the first electrical contact EC1) of the antenna 140, and may provide the signal induced in the antenna 140 to the NFC chip 120 through the first reception terminal RX1. Also, the second reception capacitor C_{RX2} and the second reception resistor R_{RX2} are connected between the second reception terminal RX2 and the second end (i.e., the second electrical contact EC2) of the antenna 140, and may provide the signal induced in the antenna 140 to the NFC chip 120 through the second reception terminal RX2.

The filter circuit 150 may include a first filter 151 and a second filter 152. The first filter 151 may include a third inductor L3 connected between the first transmission terminal TX1 and the node N3 and a seventh capacitor C7 having a first end connected to the node 3 and a second end grounded. The third inductor L3 and the seventh capacitor C7 may be connected to the fifth capacitor C5 at the node N3.

The second filter 152 may include a fourth inductor L4 connected between the second reception terminal RX2 and the node N4 and an eighth capacitor C8 having a first end connected to the node N4 and a second end grounded. The fourth inductor L4 and the eighth capacitor C8 may be connected to the sixth capacitor C6 at the node N4.

According to the present embodiment, the differential NFC signal (i.e., differential excitation current) generated by the NFC chip 120 may be input to the first end (i.e., the first electrical contact EC1) of the antenna 140 formed in the first conductive structure 510 and the second end (i.e., the second electrical contact EC2) of the antenna 140 formed in the second conductive structure 530, respectively, and thus a closed loop may be formed to operate as an antenna of a differential structure. Therefore, unlike an antenna of a single-ended structure in which an NFC signal is received by any one of two ends and the other end is grounded, the need to add a balanced to unbalanced element for conversion between unbalanced signals (i.e., differential signal/single-ended signal) to the matching circuit 130 may be eliminated.

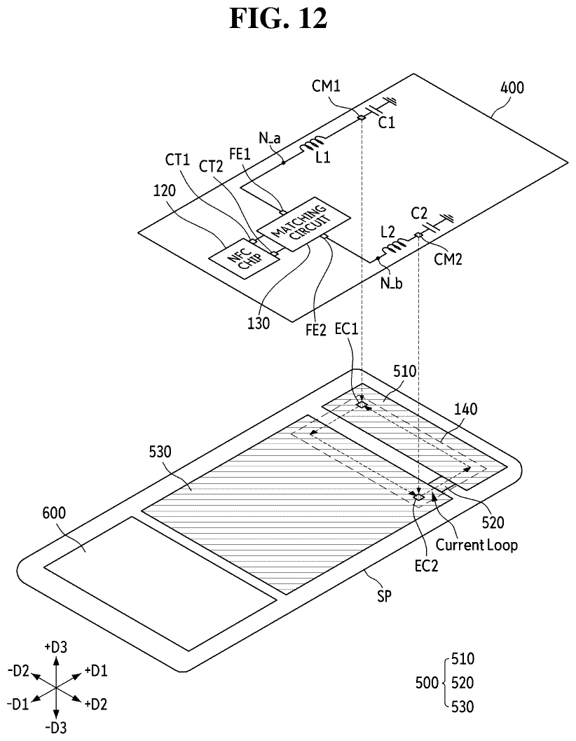

FIG. 12 is a view illustrating an electronic device including an antenna apparatus according to some embodiments.

Hereinafter, a redundant description of the above-described embodiment will be omitted, and the following description will be based on a difference from the above-described embodiment.

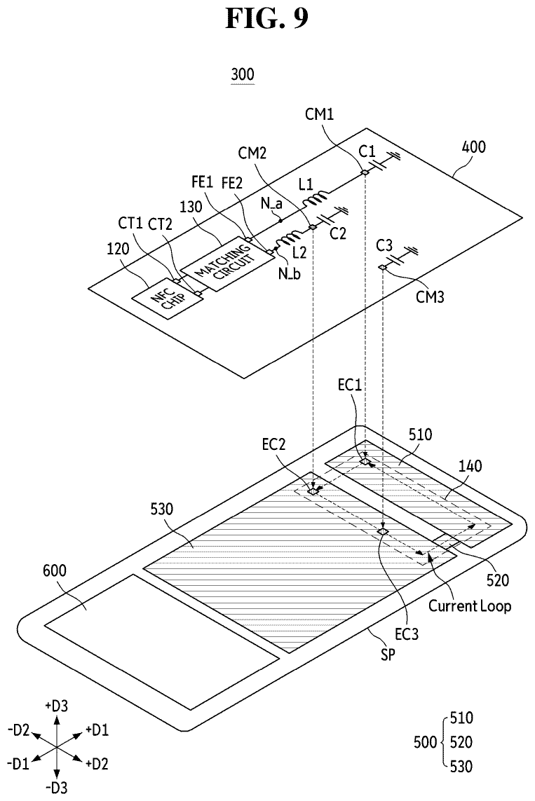

Referring to FIGS. 9 and 12 together, in the electronic device 300 of FIG. 9, the first electrical contact EC1 of the first conductive structure 510 and the second electrical contact EC2 of the second conductive structure 530 may be disposed at the same side in a second direction +D2. For example, the first electrical contact EC1 and the second electrical contact EC2 may be disposed at the same side in a second direction −D2. Alternatively, in the electronic device of FIG. 12, the first electrical contact EC1 of the first conductive structure 510 and the second electrical contact EC2 of the second conductive structure 530 may be disposed at different side portions in a second direction D2. For example, the first electrical contact EC1 may be disposed at one side in the second direction −D2 of the first conductive structure 510, and the second electrical contact EC2 may be disposed at one side in the second direction +D2 of the second conductive structure 530.

According to the present disclosure, the position where the first electrical contact EC1 is disposed in the first conductive structure 510 and the position where the second electrical contact EC2 is disposed in the second conductive structure 530 are not limited to the positions shown in FIG. 9 or 12, and a closed loop for the first conductive structure 510 and the second conductive structure 530 to operate as antennas may be formed in accordance with the position where the first electrical contact EC1 is disposed in the first conductive structure 510 and the position where the second electrical contact EC2 is disposed in the second conductive structure 530.

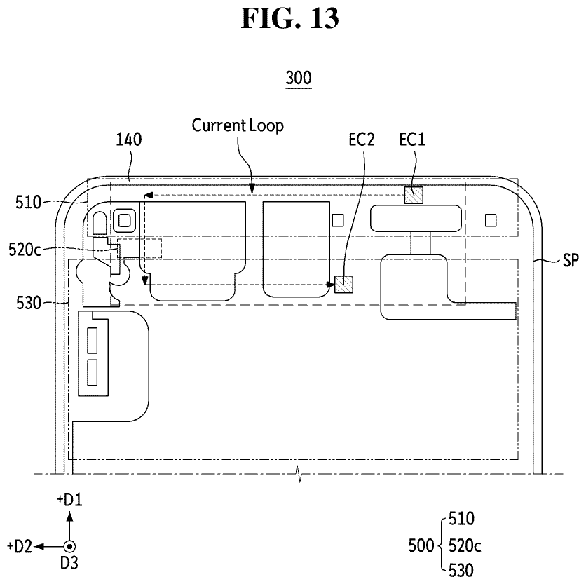

FIGS. 13 to 15 are views illustrating an electronic device according to some embodiments.

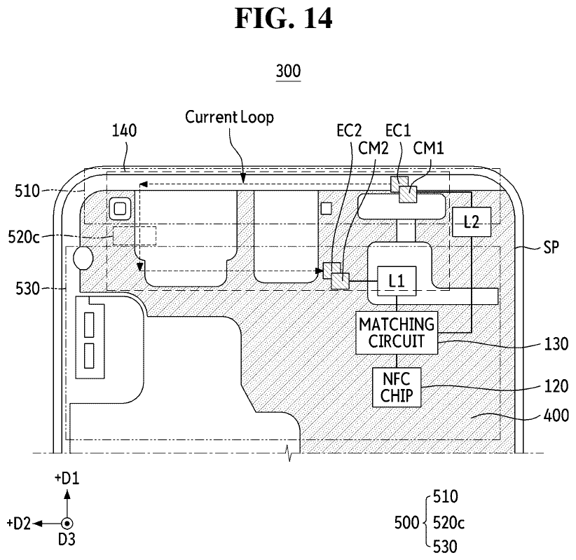

First, referring to FIGS. 13 and 14, FIG. 13 is a plan view illustrating the first conductive structure 510 and the second conductive structure 530 (shown in phantom from a rear side of the electronic device 300), which are coupled to the support member SP. FIG. 14 is a plan view illustrating that the first conductive structure 510 and the second conductive structure 530 of FIG. 13, which are coupled to the PCB 400, as viewed in phantom from a rear surface of the electronic device 300 (additional components and connection elements are shown in FIG. 14).

Referring to FIG. 13, the first conductive structure 510 may be provided on the support member SP, and a region in which the first conductive structure 510 is provided may correspond to an upper end region of the electronic device 300. The second conductive structure 530 may be provided on the support member SP by being spaced apart from the first conductive structure 510 in the first direction −D1, and the region in which the second conductive structure 530 is provided may correspond to an intermediate area of the electronic device 300. The first conductive structure 510 and the second conductive structure 530 may be connected to each other through a third conductive member 520c disposed therebetween. The first conductive structure 510 may include a first electrical contact EC1, and the second conductive structure 530 may include a second electrical contact EC2.

Referring to FIGS. 13 and 14 together, the PCB 400 may be disposed on the first conductive structure 510. For example, the PCB 400 may be coupled to the first conductive structure 510 and the second conductive structure 530 such that the first contact member CM1 of the PCB 400 is electrically connected to the first electrical contact EC1, and the second contact member CM2 of the PCB 400 is electrically connected to the second electrical contact EC2. Accordingly, a current corresponding to an NFC signal may flow along a current loop including the first electrical contact EC1 and the second electrical contact EC2, and at least a portion of the first conductive structure 510 and at least a portion of the second conductive structure 530 may operate as an antenna for NFC communication of the electronic device 300.

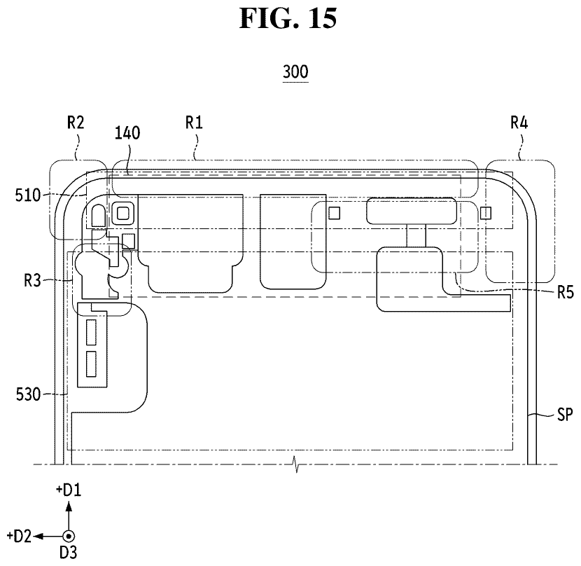

Next, referring to FIG. 15, a plurality of regions R1 to R5 may be disposed on the upper end of the electronic device 300. Each of the plurality of regions R1 to R5 may be regions allocated for non-NFC communication of the electronic device 300. For example, each of the plurality of regions R1 to R5 may be a region in which a radiator of an antenna, a ground region, etc. are disposed for the electronic device 300 to perform non-NFC communication such as LTE, GPS and Wi-Fi. The antenna 140 formed by combining at least a portion of the first conductive structure 510 with at least a portion of the second conductive structure 530 may be also used as an antenna for transmitting and receiving signals when the electronic device 300 performs non-NFC communication.

However, as shown in FIG. 14, since the first inductor L1 and the second inductor L2 serving as RF chokes to remove a high frequency component are connected between the matching circuit 130 and the first end (i.e., the first electrical contact EC1) of the antenna 140 and between the matching circuit 130 and the second end (i.e., the second electrical contact EC2) of the antenna 140, respectively, performance of NFC communication may not be degraded due to interference of the non-NFC communication.

In accordance with the above description, a method for near field signal exchange (e.g., NFC communication) may include separating a first conductive plate (e.g., 510) and a second conductive plate (e.g., 530) by a gap g and electrically connecting the first and second conductive plates with a conductive cross member (e.g., 520) extending across the gap. The first and second conductive plates have first and second contact points, EC1 and EC2, respectively. The method includes connecting a first capacitor C1 between the first contact point and a first ground point GP1 of a PCB; connecting a second capacitor C2 between the second contact point and a second ground point of the PCB; and generating, by a near field signal exchange circuit having first and second output terminals (e.g., CT1 and CT2), a differential excitation current along a loop including the first and second output terminals, the first and second contact points EC1 and EC2, a first inductor L1 coupled between the first output terminal and the first contact point, and a second inductor L2 coupled between the second output terminal and the second contact point. The near field signal exchange circuit may be a circuit within an NFC chip (e.g., 120). The NFC chip and a matching circuit (e.g., 130) coupled between the NFC chip and the first and second inductors may be mounted on the PCB.

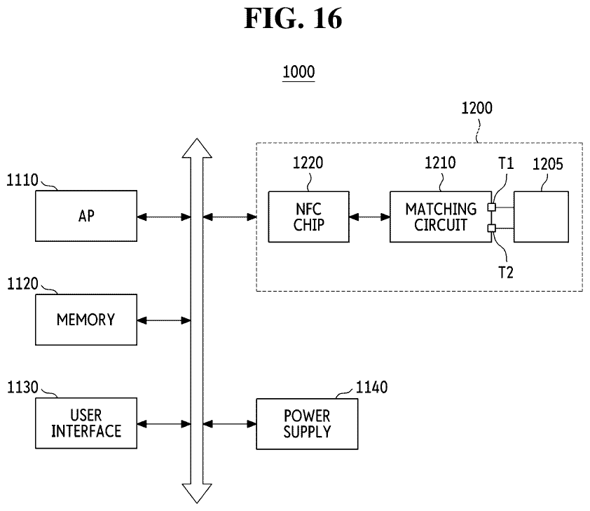

FIG. 16 is a diagram illustrating an electronic system including an antenna apparatus according to some embodiments.

Referring to FIG. 16, the electronic system 1000 may include an application processor (AP) 1110, an antenna apparatus 1200, a memory 1120, a user interface 1130, and a power supply 1140. According to the embodiment, the electronic system 1000 may be an arbitrary mobile system such as a mobile phone, a smart phone, a personal digital assistant (PDA), a portable multimedia player (PMP), a digital camera, a music player, a portable game console, a navigation system and a laptop computer.

The application processor 1110 may control the overall operation of the electronic system 1000. The application processor 1110 may execute applications that provide an Internet browser, game, video, and the like. According to the embodiment, the application processor 1110 may include a single processor core or a plurality of processor cores. For example, the application processor 1110 may include a multi-core such as a dual-core, a quad core, and a hexa-core.

In addition, according to the embodiment, the application processor 1110 may further include a cache memory located inside or outside. The memory 1120 may store data necessary for the operations of the electronic system 1000. For example, the memory 1120 may store a boot image for booting the electronic system 1000, and may store output data to be transmitted to an external device and input data received from the external device. For example, the memory 1120 may be implemented as an Electrically Erasable Programmable Read-Only Memory (EEPROM), a Flash Memory, a Phase Change Random Access Memory (PRAM), a Resistance Random Access Memory (RRAM), a Nano Floating Gate Memory (NFGM), a Polymer Random Access Memory (PoRAM), a Magnetic Random Access Memory (MRAM), a Ferroelectric Random Access Memory (FRAM) or their similar memory.

The antenna apparatus 1200 may be configured as the antenna apparatus 100 of FIG. 1. The antenna apparatus 1200 may transmit the output data stored in the memory 1120 to the external device through nearby field communication (NFC), and may store the input data received from the external device in the memory 1120. The antenna apparatus 1200 may include an antenna 1205, a matching circuit 1210, and an NFC chip 1220. The antenna 1205 may be implemented as the antenna 140 described with reference to FIG. 2, etc., and the matching circuit 120 may be implemented as the matching circuit 130 described with reference to FIG. 2, etc. The NFC chip 1220 may be implemented as the NFC chip 120 described with reference to FIG. 1, etc.

The matching circuit 1210 may generate a field voltage Vf in response to the electromagnetic wave EMW and provide the generated field voltage Vf to the NFC chip 1220. The NFC chip 1220 may detect whether an NFC card or an NFC reader is present therearound based on a magnitude of the field voltage Vf. When the NFC card is detected, the NFC chip 1220 may set a resonance frequency of a resonance circuit part 170 included in the matching circuit 130 to a first optimal frequency based on the magnitude of the field voltage Vf and may operate in a reader mode. When the NFC reader is detected, the NFC chip 1220 may set a resonance frequency of the resonance circuit part 170 included in the matching circuit 130 to a second optimal frequency based on at least one of the magnitude of the field voltage Vf and a magnitude of an internal current generated in response to the electromagnetic wave, and may operate in a card mode.

The user interface 1130 may include one or more input devices such as a keypad and a touch screen, and/or one or more output devices such as a speaker and a display device. The power supply 1140 may supply an operating voltage of the electronic system 1000. Also, according to the embodiment, the electronic system 1000 may further include an image processor, and may further include a storage device such as a memory card, a solid state drive (SSD), a hard disk drive (HDD), and a CD-ROM.

The components of the electronic system 1000 may be packaged using various types of packages, for example, Package on Package (PoP), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flat-Pack (TQFP), Small Outline Integrated Circuit (SOIC), Shrink Small Outline Package (SSOP), Thin Small Outline Package (TSOP), Thin Quad Flat-Pack (TQFP), System In Package (SIP), Multi Chip Package (MCP), Wafer-level Fabricated Package (WFP) and Wafer-Level Processed Stack Package (WSP).

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or characteristics of the present disclosure. Therefore, it should be appreciated that the embodiments as described above are not restrictive but illustrative in all respects.

What is claimed IS:

1. An antenna apparatus comprising:
a first conductive structure including a first electrical contact;
a second conductive structure adjacent to the first conductive structure and including a second electrical contact; and
a printed circuit board (PCB), coupled to the first conductive structure and the second conductive structure, on which a matching circuit and a near field communication (NFC) chip are disposed, the matching circuit including a first feeding end and a second feeding end, the first feeding end being reactively coupled to the first electrical contact, and the second feeding end being reactively coupled to the second electrical contact,
wherein,
the PCB includes a first ground point and a second ground point, the first ground point being reactively coupled to the first feeding end, and the second ground point being reactively coupled to the second feeding end,
the NFC chip includes a first connection terminal and a second connection terminal,
the first connection terminal and the second connection terminal together provide a differential excitation current,
the first connection terminal is coupled to the first feeding end through the matching circuit,
the second connection terminal is coupled to the second feeding end through the matching circuit, and
a current corresponding to an NFC frequency is formed along a loop that includes the first electrical contact and the second electrical contact.

2. The antenna apparatus of claim 1, wherein the PCB further includes:
a first contact member connected between the first feeding end and the first ground point; and
a second contact member connected between the second feeding end and the second ground point, and
when the PCB is coupled to the first conductive structure and the second conductive structure, the first contact member is electrically connected to the first electrical contact, and the second contact member is electrically connected to the second electrical contact.

3. The antenna apparatus of claim 2, wherein the PCB further includes:
a first inductor connected between the first feeding end and the first contact member; and
a second inductor connected between the second feeding end and the second contact member.

4. The antenna apparatus of claim 3, wherein the PCB further includes:
a first capacitor connected between the first contact member and the first ground point, wherein the first inductor and the first capacitor provide the reactive coupling between the first ground point and the first feeding end; and
a second capacitor connected between the second contact member and the second ground point, wherein the second inductor and the second capacitor provide the reactive coupling between the second ground point and the second feeding end.

5. The antenna apparatus of claim 1, wherein a portion of the first conductive structure including the first electrical contact and a portion of the second conductive structure including the second electrical contact form radiating structures of an antenna,
the matching circuit includes a resonance circuit part including a first capacitor connected in parallel with the antenna between the first electrical contact and the second electrical contact,
a first end of the first capacitor is connected to the first feeding end,
a second end of the first capacitor is connected to the second feeding end,
a first inductor is connected between the first feeding end and a first contact member connected between the first ground point and the first feeding end, and
a second inductor is connected between the second feeding end and a second contact member connected between the second ground point and the second feeding end.

6. The antenna apparatus of claim 5, wherein the NFC chip is connected to the matching circuit through the first connection terminal and the second connection terminal,
the first connection terminal includes a first transmission terminal and a first reception terminal,
the second connection terminal includes a second transmission terminal and a second reception terminal, and
the matching circuit further includes a matching sub-circuit, the matching sub-circuit including:
a first reception capacitor having a first end connected to the first reception terminal;
a first reception resistor having a first end connected to a second end of the first reception capacitor and a second end connected to the first end of the first capacitor;
a second reception capacitor having a first end connected to the second reception terminal;
a second reception resistor having a first end connected to a second end of the second reception capacitor and a second end connected to the second end of the first capacitor;
a second capacitor having a first end connected to the second end of the first reception resistor and the first end of the first capacitor; and
a third capacitor having a first end connected to the second end of the second reception resistor and the second end of the first capacitor.

7. The antenna apparatus of claim 6, wherein the matching circuit further includes a filter circuit including a first filter connected to the first transmission terminal and a second filter connected to the second transmission terminal,
the first filter includes a third inductor including a first end connected to the first transmission terminal and a second end connected to a first node, and a fourth capacitor including a first end connected to the first node and a second end that is grounded, and
a second end of the second capacitor is connected to the first node.

8. The antenna apparatus of claim 7, wherein the second filter includes a fourth inductor having a first end connected to the second transmission terminal and a second end connected to a second node, and a fifth capacitor having a first end connected to the second node and a second end that is grounded, and
a second end of the third capacitor is connected to the second node.

9. The antenna apparatus of claim 1, wherein:
the first conductive structure is spaced apart from the second conductive structure in a first direction;
the antenna apparatus further includes a conductive cross member disposed between the first conductive structure and the second conductive structure and extended in the first direction, and
the conductive cross member includes a first end and a second end, which are opposite to each other in the first direction, and
the first end is connected to or part of the first conductive structure and the second end is connected to or part of the second conductive structure.

10. The antenna apparatus of claim 9, wherein the current corresponding to the NFC frequency is formed along the conductive member.

11. The antenna apparatus of claim 9, wherein the first conductive structure has an oblong profile, and a longest dimension of the oblong profile extends along a second direction intersecting the first direction,
the second conductive structure has a side adjacent to the first conductive structure that extends along the second direction, and
a majority path of the current corresponding to the NFC frequency is formed in the first conductive structure along the second direction and formed in the second conductive structure along the second direction.

12. The antenna apparatus of claim 1, wherein the first conductive structure is spaced apart from the second conductive structure in a first direction, and
the PCB is disposed on the first conductive structure and the second conductive structure and coupled to the first conductive structure and the second conductive structure to cover the first conductive structure and the second conductive structure.

13. An antenna apparatus comprising:
a first conductive structure including a first electrical contact;
a second conductive structure spaced apart from the first conductive structure in an opposite direction of a first direction and including a second electrical contact; and
a printed circuit board (PCB) coupled to the first conductive structure and the second conductive structure, on which a matching circuit, a near field communication (NFC) chip, a first contact member and a second contact member are disposed, the matching circuit including a first feeding end connected to the first contact member and a second feeding end connected to the second contact member,
wherein the NFC chip includes a first connection terminal and a second connection terminal,
the first connection terminal and the second connection terminal together provide a differential excitation current,
the first connection terminal is connected to the first feeding end through the matching circuit,
the second connection terminal is connected to the second feeding end through the matching circuit,
when the PCB is coupled to the first conductive structure and the second conductive structure, a current input and output to the NFC chip through the first connection terminal is input and output to the first conductive structure through the first electrical contact, and a current input and output to the NFC chip through the second connection terminal is input and output to the second conductive structure through the second electrical contact,
a current corresponding to an NFC frequency is formed along a loop, and
the loop is formed across the first conductive structure and the second conductive structure.

14. The antenna apparatus of claim 13, wherein the PCB further includes:
a first inductor having a first end connected to the first feeding end and a second end connected to the first contact member;
a second inductor having a first end connected to the second feeding end and a second end connected to the second contact member;
a first ground point reactively coupled to the first inductor; and
a second ground point reactively coupled to the second inductor.

15. The antenna apparatus of claim 14, wherein the PCB further includes:
a first capacitor having a first end connected to the first contact member and a second end connected to the first ground point; and
a second capacitor having a first end connected to the second contact member and a second end connected to the second ground point.

16. The antenna apparatus of claim 13, wherein a portion of the first conductive structure including the first electrical contact and a portion of the second conductive structure including the second electrical contact form radiating structures of an antenna,
the matching circuit is connected between the antenna and the NFC chip, and includes a resonance circuit part including a first capacitor connected to the antenna in parallel, which responds to an electromagnetic wave, between the first electrical contact and the second electrical contact, and a matching sub-circuit connected to the resonance circuit part in parallel, performing impedance matching between the antenna and the NFC chip.

17. The antenna apparatus of claim 16, wherein a first end of the first capacitor is connected to the first feeding end,
a second end of the first capacitor is connected to the second feeding end, and
the PCB further includes a first inductor having a first end connected to the first feeding end and a second end connected to the first electrical contact through the first contact member, and
a second inductor having a first end connected to the second feeding end and a second end connected to the second electrical contact through the second contact member.

18. The antenna apparatus of claim 17, wherein the NFC chip is connected to the matching circuit through a first transmission terminal and a second transmission terminal,
the matching circuit includes a first LC filter circuit connected to the first transmission terminal and a second LC filter circuit connected to the second transmission terminal, and
the matching sub-circuit includes a second capacitor having a first end connected to the first end of the first capacitor, a second capacitor having a second end connected to the first LC filter circuit, and a third capacitor having a first end connected to the second end of the first capacitor and a second end connected to the second LC filter circuit.

19. An electronic device comprising:
a radiator including a first electrical contact and a second electrical contact;
an antenna apparatus including a printed circuit board (PCB) coupled to the radiator, on which a matching circuit and a near field signal exchange chip are disposed, the matching circuit including a first feeding end and a second feeding end, the first feeding end being connected to the first electrical contact, and the second feeding end being connected to the second electrical contact; and
a first conductive structure, an edge portion of which forms a portion of the radiator,
wherein the first electrical contact is included in the first conductive structure, and the second electrical contact is included in a second conductive structure spaced apart from the edge portion of the first conductive structure,
the PCB includes a first ground point and a second ground point, the first ground point being reactively coupled to the first feeding end and the second ground point being reactively coupled to the second feeding end,
the near field signal exchange chip includes a first connection terminal and a second connection terminal,
the first connection terminal and the second connection terminal together provide a differential excitation current,
the first connection terminal is connected to the first feeding end through the matching circuit,
the second connection terminal is connected to the second feeding end through the matching circuit, and
a current corresponding to a near field signal exchange frequency is formed within the first conductive structure and the second conductive structure.

20. The electronic device of claim 19, wherein the first conductive structure is spaced apart from the second conductive structure in a first direction, and the current corresponding to the near field signal exchange frequency flows, in part, adjacent to one end of the second conductive structure in the first direction.
